(19) United States
(12) Patent Application Publication
(10) Pub. No.: US 2015/0307808 A1
(43) Pub. Date: Oct. 29, 2015

(54) Siloxane Traction Fluids with Ring-Shaped Branch Structures and Method of Using

(71) Applicants: Dow Corning Corporation, Midland, MI (US); Northwestern University, Evanston, IL (US)

(72) Inventors: Andreas STAMMER, Pont-a-celles (BE); Manfred JUNGK, Geisenheim (DE); Herbert STOEGBAUER, Huenfelden (DE); Yip-Wah CHUNG, Wilmette, IL (US); Tobin J. MARKS, Evanston, IL (US); Qian Jane WANG, Mt. Prospect, IL (US); Thomas J. ZOLPER, Cuba City, WI (US)

(21) Appl. No.: 14/647,507

(22) PCT Filed: Nov. 27, 2013
(86) PCT No.: PCT/US2013/072130

§ 371 Date: May 27, 2015

Related U.S. Application Data
(60) Provisional application No. 61/730,826, filed on Nov. 28, 2012.

(51) Int. Cl. C10M 171/00; C08G 77/04

(52) U.S. Cl. CPC C10M 171/002; C08G 77/04

(57) ABSTRACT

Traction fluids and a method of using such tractions fluids to increase the interface friction between two surfaces moved relative to one another is provided. The traction fluid may comprise a polysiloxane base oil corresponding to the structural formula:

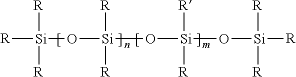

wherein R and R′ are independently selected, such that R is an alkyl group having between 1-3 carbon atoms; R′ is a cycloalkyl dicycloalkyl, or aryl group having between 5-20 carbon atoms; m is an integer; and n is an integer or 0 with 5<(m+n)<100 and 0.50<m/(m+n)<1.00.

This disclosure relates generally to traction fluids used to increase the interface friction between two mechanical surfaces when the surfaces are moved relative to one another. More specifically, this disclosure relates to traction fluids that comprise a polysiloxane base oil having a combination of alkyl functionality and at least one selected from the group aryl, diaryl, cycloalkyl, or dicycloalkyl functionality. This disclosure further relates to the use of said polysiloxane base oils, as well as the use of a poly(alkylaryl)siloxane base oils as a traction fluid.

The statements in this section merely provide background information related to the present disclosure and may not constitute prior art.

Traction drives, such as continuously variable transmissions (CVTs), have been in development for decades, leading to an array of configurations in modern applications. Many industrial, automotive and aerospace companies have investigated different types of traction drives for their production lines to increase efficiency and reduce transmission components. Traction drives, such as CVTs, have been tested in various engine applications for their potential to improve vehicle performance and extend engine life by running at the maximum power, or efficiency, at a constant engine speed. However, implementation of traction drives in automotive applications is beset with lingering functional and financial challenges, including component weight, durability, and cost.

Traction drives, such as toroidal, conical, or planetary CVTs, are used to transmit torque or effectively transmit a force from one machine element to another without the use of gears. Traction drives typically transfer force through point or line contacts rather than the larger surface areas that characterize clutches and brakes. The fluids required for traction drives differ from more general lubricated interfaces because these fluids are required to increase the interface friction between the driving and the driven components while maintaining good surface protection and low wear. The extreme pressures and shear conditions of a traction drive can subject a traction fluid to shear stresses that can reduce its effectiveness by causing molecular breakdown.

Elastohydrodynamic (EHD) friction, μ_{EHD}, also known as traction is a key performance parameter in traction fluids. Successful traction fluids should have a higher EHD friction than normal lubricants while maintaining sufficiently low viscosity at low temperatures to allow its circulation during start-up and sufficiently high viscosity at high temperatures to support the designed load when fully warm-up. Additional requirements include chemical inertness toward the metal surfaces in contact, reasonable lubrication properties, and heat dissipation.

Hydrocarbon-based fluids including aliphatic, naphthenic, and cycloalkyl branched hydrocarbon structures have been tested for traction performance. Various natural seed oils including olive, sesame, canola and soybean oil, have also been evaluated for film formation and traction performance. Several synthetic lubricants, including silahydrocarbons, siloxanes, and perfluorinated polyalkylethers, have also been investigated to examine their tribological performance.

Siloxane-based polymers have silicon-oxygen backbones instead of the carbon-carbon backbones that are present in hydrocarbons. Siloxanes have been shown to have greater oxidative stability and lower viscosity temperature dependence than many hydrocarbon polymers. In addition, siloxane molecules are more flexible than the corresponding hydrocarbons because they exhibit less steric hindrance relative to chain rotation around the backbone structure. This low steric hindrance is attributed to factors including the longer Si—O bond (0.164 nm, cf. 0.153 nm for C—C), the oxygen atoms not being encumbered by side groups, and the greater Si—O—Si bond angle (about 143°, cf. about 110° for C—C—C). The enhanced flexibility of siloxanes allows for increased compactness, lower melting temperatures, and lower glass transition temperatures.

Permanent viscosity breakdown known as ‘molecular scission’ occurs when the polymers are mechanically broken into shorter-lower mass segments by the high shear stresses in a tribological contact. A tribological contact comprises a lubricant interface with a first surface in a machine element, the fluid lubricant film, and a lubricant interface with a second surface in the machine element, such that the shear stresses occur mainly within the lubricant film and to a lesser degree at the machine element/lubricant interface. Industrial lubricants are often required to pass stringent shear tests such as the shear stability index (PSSI) to confirm their permanent shear stability. Siloxanes are known to be more resilient to permanent viscosity breakdown than competing hydrocarbons. In fact, polysiloxanes have a permanent shear threshold that is an order of magnitude greater than organic polymers. It is possible that the oxidative stability and strong Si—O bonds of siloxane may also improve its resistance to molecular breakdown.

Siloxanes are generally derived from reacting silicon with methyl chloride to produce dimethyldichlorosilanes, which are then mixed with water to produce silanols, followed by polymerization. One example of a conventional siloxane polymer is polydimethylsiloxane (PDMS) as shown in Structure S-I. PDMS is composed of a backbone chain of alternating silicon and oxygen atoms with methyl groups bonded to the silicon atoms. PDMS is known to provide poor boundary lubrication properties. However, the replacement of methyl groups with other groups, such as phenyl groups, as shown for poly(phenylmethyl dimethyl)siloxane (PPMS) in Structure S-II can lead to a reduction in boundary friction and wear. Poly(phenylmethyl dimethyl)siloxane (PPMS) has phenylmethyl D units in place of some dimethyl D units (as further defined below and herein) and is prepared by hydrolyzation of dimethyldichlorosilane and methylphenyldichlorosilane followed by polymerization. Such a replacement will also lead to an increase in the molecular rigidity of siloxane polymer when used in sufficient quantity. PPMS exhibits both increased wear resistance and oxidative stability, but also a decrease in molecular flexibility.

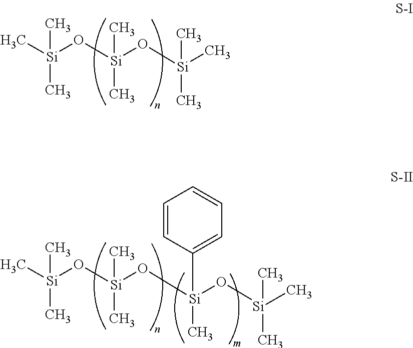

### BRIEF SUMMARY OF THE INVENTION

The present disclosure generally provides a traction fluid and for the use of said traction fluid to increase the interface friction between two mechanical surfaces when the surfaces are moved relative to one another. According to one aspect of the present disclosure the traction fluid comprises a polysiloxane base oil corresponding to the structural formula:

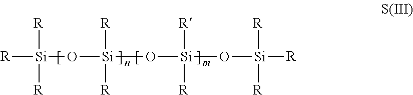

wherein R and R′ are independently selected, such that R is an alkyl group having between 1-3 carbon atoms; R′ is a cycloalkyl or dicycloalkyl group having between 5-20 carbon atoms; m is an integer, and n is an integer or 0 with 5<(m+n)<100 and 0.50<m/(m+n)<1.00. Alternatively, R is a methyl group and R′ is a cyclohexyl or cyclopentyl group.

The traction fluid may further comprise at least one functional additive selected as one from the group of extreme pressure additives, anti-wear additives, antioxidants, and corrosion inhibitors. The traction fluid may also comprise one or more compatible base oils having a degree of polymerization between 15 and 500; the compatible base oil being selected as polydimethylsiloxane or poly(phenylmethyl dimethyl)siloxane with between 5 and 30 wt. % phenylmethyl D unit content (as further defined below and herein).

According to another aspect of the present disclosure the use of one or more polysiloxane base oils as a low wear, traction fluid capable of increasing the interface friction between two mechanical surfaces when the surfaces are moved relative to one another is provided. The polysiloxane base oil may correspond to the structural formula shown above and provided herein as structure S-III, wherein R and R′ are independently selected, such that R is an alkyl group having between 1-3 carbon atoms; R′ is a cycloalkyl or aryl group having between 5-20 carbon atoms; m is an integer, and n is an integer or 0 with 5<(m+n)<100 and 0.50<m/(m+n)<1.00. Alternatively, the R is a methyl group and R′ is an aryl or a cycloalkyl group with 7<(m+n)<100. Alternatively, the R is a methyl group and R′ is a diaryl or a dicycloalkyl group. Alternatively, the R is a methyl group and R′ is a cyclohexyl or cyclopentyl group. Alternatively, the polysiloxane base oil corresponds to structural formula:

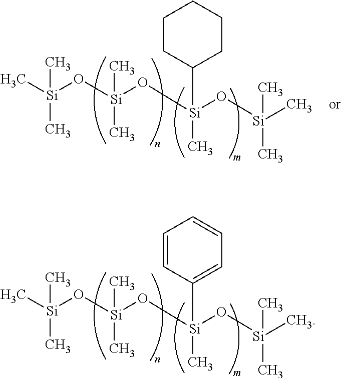

The traction fluid used herein may further comprise at least one functional additive selected as one from the group of extreme pressure additives, anti-wear additives, antioxidants, and corrosion inhibitors. This traction fluid may also include one or more compatible base oils that have a degree of polymerization between about 15 and about 500; the compatible base oil being selected as trimethyl silyl terminated polydimethylsiloxane or trimethyl silyl terminated poly(phenylmethyl dimethyl)siloxane with between about 5 and 30 wt. % phenylmethyl D unit content.

According to another aspect of the present disclosure, a method of increasing the interface friction between two mechanical surfaces when the surfaces are moved relative to one another is provided. This method generally comprises the steps of providing a machine element having a first surface and a second surface, such that the first and second surfaces represent a contact point in the machine element; providing a traction fluid between the first surface and second surface; and allowing the first surface to roll or slide past the second surface such that the traction fluid increases the interface friction between the first and second surfaces.

The traction fluid used in this method comprises at least one polysiloxane base oil corresponding to the structural formula shown above or described herein as S-III, where R and R′ are independently selected, such that R is an alkyl group having between 1-3 carbon atoms; R′ is a cycloalkyl or aryl group having between 5-20 carbon atoms; m is an integer, and n is an integer or 0 with 5<(m+n)<100 and 0.50<m/(m+n)<1.00. Alternatively, the R is a methyl group and R′ is an aryl or a cycloalkyl group with 7<(m+n)<100. Alternatively, the R is a methyl group and R′ is a diaryl or a dicycloalkyl group. Alternatively, the R is a methyl group and R′ is a cyclohexyl or cyclopentyl group. Alternatively, the traction fluid further comprises a functional additive or at least one compatible base oil as previously described or further defined herein.

According to another aspect of the present disclosure, the two mechanical surfaces (first and second) that move relative to one another are part of a traction drive and the traction fluid is a grease, a gear oil, or a transmission fluid. Alternatively, the two surfaces represent an elastohydrodynamic lubrication (EHL) contact point in the machine element. Alternatively, the first and second surfaces are ceramic or metal surfaces; alternatively, they are both metal surfaces.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a cross-sectional depiction of an elastrohydrodynamic (EHD) rig for use in film thickness and traction measurements;

FIG. 2 is a graphical representation of elastohydrodynamic liquid (EHL) film thickness exhibited by a poly(phenylmethyl dimethyl)siloxane (PPMS-3) base oil at various temperatures plotted as a function of entrainment speed;

FIG. 3 is a graphical representation of elastohydrodynamic liquid (EHL) film thickness exhibited by a poly(cyclohexylmethyl dimethyl)siloxane (PCMS-1) base oil at various temperatures plotted as a function of entrainment speed;

FIG. 4 is a graphical representation of elastohydrodynamic liquid (EHL) film thickness exhibited by a highly branched poly(cyclohexylmethyl dimethyl)siloxane (PCMS-2) base oil at various temperatures plotted as a function of entrainment speed;

FIG. 5 is a graphical representation of elastohydrodynamic liquid (EHL) film thickness exhibited by a poly(diphenyl dimethyl)siloxane (PDPS-1) base oil at various temperatures plotted as a function of entrainment speed;

FIG. 6 is a graphical representation of the friction coefficient exhibited by a conventional oil (C-1) and several traction fluids (PCMS-1, PPMS-3) prepared according to the present disclosure at a temperature of 303K plotted as a function of film thickness;

FIG. 7 is another graphical representation of the friction coefficient exhibited by a conventional oil (C-1) and several traction fluids (PPMS-4, PDPS-1) prepared according to the present disclosure at a temperature of 303K plotted as a function of film thickness;

FIG. 8 a graphical representation of the friction coefficient exhibited by a conventional oil (C-1) and several traction fluids (PCMS-1, PPMS-3) prepared according to the present disclosure at a temperature of 398K plotted as a function of film thickness;

FIG. 9 another graphical representation of the friction coefficient exhibited by a conventional oil (C-1) and several traction fluids (PCMS-2, PPMS-4) prepared according to the present disclosure at a temperature of 398K plotted as a function of film thickness;

FIG. 10 is a graphical representation of the friction coefficient exhibited by a poly(phenylmethyl dimethyl)siloxane (PPMS-4) base oil at various temperatures plotted as a function of film thickness;

FIG. 11 is a graphical representation of the limiting EHD friction coefficient exhibited by poly(phenylmethyl dimethyl)siloxane base oils at various temperatures plotted as a function of phenylmethyl D unit content;

FIG. 12 is a graphical representation of the limiting EHD friction coefficient exhibited by poly(cyclohexylmethyl dimethyl)siloxane base oils at various temperatures plotted as a function of cyclohexylmethyl D unit content;

FIG. 13 is a graphical representation of the limiting EHD friction coefficient exhibited by poly(phenylmethyl dimethyl)siloxane base oils at various temperatures plotted as a function of pressure viscosity index;

FIG. 14 is a graphical representation of the limiting EHD friction coefficient exhibited by several polysiloxane base oils prepared according to the teachings of the present disclosure and conventional oil at various temperatures plotted as a function of pressure viscosity index; and

FIG. 15 is a schematic representation of a method of using a traction fluid comprising a polysiloxane base oil to increase the interface friction between two mechanical surfaces when the surfaces are moved relative to one another.

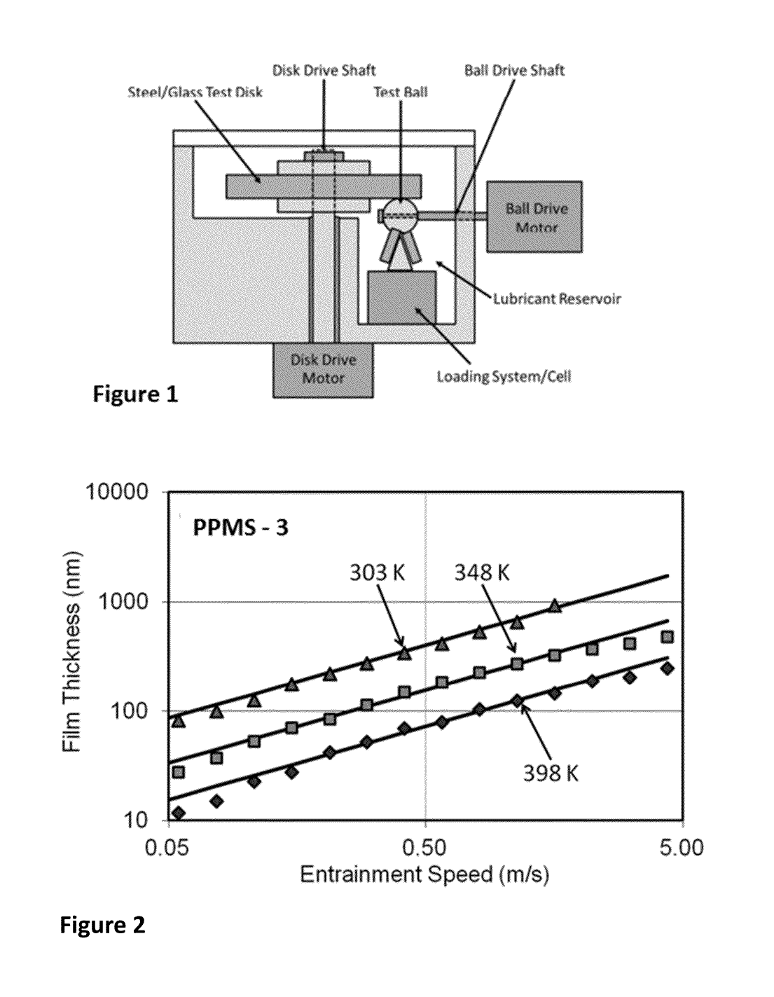

### DETAILED DESCRIPTION

The following description is merely exemplary in nature and is in no way intended to limit the present disclosure or its application or uses. It should be understood that throughout the description, corresponding reference numerals indicate like or corresponding parts and features.

The present disclosure generally relates to a traction fluid that is capable of increasing the interface friction between two mechanical surfaces when the surfaces are moved relative to one another. More specifically, the traction fluid comprises polysiloxane base oil that has a ring-shaped branch structure.

Friction in a tribological interface may be divided into a component caused by the interaction of solid asperities and a hydrodynamic component caused by fluid viscosity. Standard lubricants and traction fluids are both used to form a film that separates running surfaces and thereby minimize friction and wear due to asperities. Standard lubricants also aim to minimize hydrodynamic friction to reduce energy losses due to viscous dissipation. Unlike standard lubricants, traction fluids are used to transfer force across a fluid film and therefore should have higher hydrodynamic (and elastohydrodynamic) friction coefficients than normal lubricants. Standard lubricants are not suitable for traction drives because the low hydrodynamic friction allows slip between the driving and driven components. Traction fluids are not desirable for lubricants such as gear oils because the higher hydrodynamic friction reduces energy efficiency.

The extreme pressures and shear conditions of a traction drive may subject a traction fluid to very large shear stresses that can reduce its effectiveness by causing molecular breakdown. Permanent viscosity breakdown known as ‘molecular scission’ occurs when the polymers of a lubricant are mechanically broken into shorter/lower mass segments by the high shear stresses at a tribological interface. Since the strength of the polysiloxane Si—O bond dissociation enthalpy (460 kJ/mol) significantly exceeds that of the corresponding C—C bond (348 kJ/mol) in hydrocarbon polymers, the siloxanes have a greater resistance to permanent chain breakdown than hydrocarbon polymers. In fact, upon the application of shear stresses, siloxanes have a permanent shear threshold that is an ‘order of magnitude’ greater than that of organic polymers.

The traction fluids and polysiloxane base oils associated therewith that are prepared and used according to the teachings contained herein are described throughout the present disclosure in conjunction with various test configurations that are appropriate for measuring film formation, friction, and rheological properties, such as a thin film ball on disk wear test defined herein in order to more fully illustrate the concept. The incorporation and use of these traction fluid compositions in conjunction with other types of sliding or rolling contacts, such as those found in various machine elements, including but not limited to, rolling element bearings, sliding bearings, gears, cams and cam followers, or traction drives, is contemplated to be within the scope of the disclosure.

According to one aspect of the present disclosure, the traction fluid comprises polysiloxane base oil having a structure described by structure (S-III). In structure S(III), R and R′ are independently selected such that R is an alkyl group having between 1-3 carbon atoms; R′ is a aryl, diaryl, cycloalkyl or dicycloalkyl group having between 5-20 carbon atoms; m is an integer; and n is an integer or 0 with 5<(m+n)<100 and 0.50<m/(m+n)<1.00. Alternatively, R is a methyl group and R′ is cyclohexyl or cyclopentyl group. Optionally, the R or R′ may also include the substitution of a hydrogen atom with a functional ligand, such as a halogen atom, e.g., fluorine, an amino group, or a carboxyl group, among others.

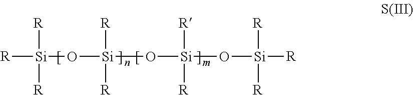

The traction fluid may further comprise one or more compatible base oils having a degree of polymerization between 15 and 500. The compatible base oil is selected as polydimethylsiloxane or poly(phenylmethyl dimethyl)siloxane with between 5 and 30 wt. % phenylmethyl D unit content. Optionally, the traction fluid may also include at least one functional additive selected as one from the group of extreme pressure additives, anti-wear additives, antioxidants, and corrosion inhibitors.

One skilled in the art will understand that although Structure S(I) is shown to include only M units (R₃SiO_{1/2}) and D units (R′RSiO_{2/2}), such structure may also comprise T units (R″SiO_{3/2}) or Q units (SiO_{4/2}) as branch points resulting in the crosslinking of polysiloxane backbones or chains without exceeding the scope of the present disclosure. The R″ group associated with any T unit that is present in the polysiloxane base oil may be independently selected and defined similarly as to the descriptions provided for the R or R′ groups above. The number of T units or Q units present in the polysiloxane base oil may be predetermined according to the viscosity and lubrication properties desired for the traction fluid when used in a specific application.

According to another aspect of the present disclosure one or more polysiloxane base oils is used as a low wear, traction fluid capable of increasing the interface friction between two mechanical surfaces when the surfaces are moved relative to one another. This polysiloxane base oil has a ring-shaped branch structure as described above in relation to structure S-III in which R and R′ are independently selected, such that R is an alkyl group having between 1-3 carbon atoms; R′ is a cycloalkyl or aryl group having between 5-20 carbon atoms; and m and n are integers with 5<(m+n)<100 and 0.50<m/(m+n)<1.00. Alternatively, the polysiloxane base oil includes R as a methyl group and R′ is an aryl or a cycloalkyl group with 7<(m+n)<100. Alternatively, the R is a methyl group and the R′ is a diaryl or a dicycloalkyl group, including but not limited to a cyclohexyl or a cyclopentyl group. Alternatively, the polysiloxane base oil corresponds to poly(phenylmethyl dimethyl)siloxane or poly(phenylmethyl)siloxane when n=0 (PPMS) described by structure S-II or poly(cyclohexylmethyl dimethyl)siloxane or poly(cyclohexylmethyl)siloxane when n=0 (PCMS) as further described below by structure S-IV.

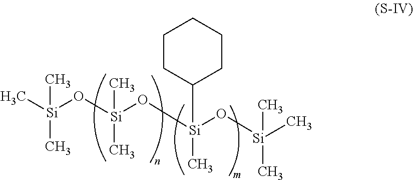

The use of the polysiloxane base oil as a traction fluid may also include one or more compatible base oils that have a degree of polymerization between about 15 and about 500. The compatible base oil is selected as polydimethylsiloxane (PDMS) or poly(phenylmethyl dimethyl)siloxane (PPMS) with between 5 and 30 wt. % phenylmethyl D unit content. A functional additive, such as one selected from the group of extreme pressure additives, anti-wear additives, antioxidants, and corrosion inhibitors may also be included in the composition of the traction fluid that is utilized.

The viscosity at atmospheric pressure (η₀) is generally used to characterize the rheological properties of a lubricant. Polymer viscosity increases with the polymer length, branch content and branch length. Viscosity increases linearly with polymer length up to a critical mass above which polymers begin to entangle and viscosity then increases exponentially with polymer length. Effective viscosity can vary significantly in a tribological interface because it is influenced by molecular structure, temperature, pressure, and interfacial shear. As molecular mass increases, the dynamic viscosity of a polysiloxane, such as PDMS, may become susceptible to temporary shear thinning, which is undesirable for traction fluids. Siloxanes with ring-shaped branches can minimize shear losses in a traction drive.

The elastohydrodynamic film thickness, hₒᵢₗ, of lubricants is modeled with rheological properties, such as atmospheric viscosity, ηₒ, and pressure-viscosity index, α, together with entrainment velocity, U. Equation 1 depicts a simplification of the Hamrock-Dowson equation, where material and geometry parameters are included in the constant k.

hₒᵢₗ=kU^{0.67}η₀^{0.67}α^{0.53} Eq. (1)

Although increasing the pressure-viscosity index improves the film forming ability of a lubricant, it also increases the EHD friction. High EHD friction causes efficiency loss in most lubricants, but importantly gives rise to efficiency gains in traction fluids. Correlations between molecular structure and pressure-viscosity index have been observed. Referring now to Equation 2, compounds with high ring content generally have high elastohydrodynamic (EHD) friction at several different loads as supported by correlations observed between EHD friction coefficient, μ_{Hyd}, and percent ring content, Q_{R}. Good traction fluids generally have a high content of ring shaped molecular structures. The success of ring structures in traction fluids is evidenced by their use in U.S. Pat. Nos. 4,577,523 and 6,623,399, the entire contents of which are hereby incorporated by reference.

μ_{Hyd}∝Q_{R}∝α Eq. (2)

Measurement of the viscosity of several siloxanes including PDMS and PPMS at elevated pressures demonstrates that increasing the phenyl ring content of siloxanes causes a significant increase in the pressure-viscosity index. The room temperature pressure-viscosity index of PPMS (27 GPa⁻¹) is approximately twice the pressure-viscosity index of PDMS (14 GPa⁻¹).

Polymers with high ring structure branching content, Q_{R}, generally exhibit high EHD friction, which can be attributed to the ability of the polymers to molecularly interlock. The performance of traction fluids can also be correlated with the molecular rigidity induced by the steric hindrance caused by ring branches.

The film thickness and friction coefficient of several different hydrocarbon polymers can also be plotted to determine the EHD friction coefficient of the different polymers at multiple temperatures. Using the measured film thickness and a reference fluid, the pressure-viscosity index of the different fluids can be approximated. A plot of EHD friction versus the pressure-viscosity index demonstrates a positive correlation. In addition, the measured radius of gyration and persistence length of alkyl and phenyl branched siloxanes can be used to determine correlations between structure and conformation. For example, the rigid rod shape of PPMS differs significantly from PDMS which is highly flexible with a random distribution. Thus using a high density of rings on a siloxane molecule increases its rigidity and causes it to take on a rod like conformation. The flow characteristic of the rigid rod structures can increase the pressure-viscosity index and the EHD friction coefficient.

The following specific embodiments are given to illustrate the design and use of polysiloxane traction fluids according to the teachings of the present disclosure and should not be construed to limit the scope of the disclosure. Those skilled-in-the-art, in light of the present disclosure, will appreciate that many changes can be made in the specific embodiments which are disclosed herein and still obtain alike or similar result without departing from or exceeding the spirit or scope of the disclosure.

### Example 1

### General Measurement Techniques

The physical and chemical properties exhibited by the traction fluids prepared according to the teachings of the present disclosure are measured using the equipment and test protocols or procedures described below and herein. One skilled in the art will understand that any properties reported herein represent properties that are routinely measured and can be obtained by multiple different methods. The methods described herein represent one such method and other methods may be utilized without exceeding the scope of the present disclosure.

Molecular Mass & Structure—

Molecular mass distributions of the polysiloxane samples are measured by gel permeation chromatography (GPC) using a Waters 2695 Separations Module equipped with a vacuum degasser and a Waters 2410 differential refractometer. The separation is made with two (300 mm×7.5 mm) Polymer Laboratories PLgel 5 μm Mixed-C columns (molecular weight separation range of 200 to 2,000,000), preceded by a PLgel 5 μm guard column (50 mm×7.5 mm). The analyses are performed using certified grade THF flowing at 1.0 mL/min as the eluent, and the columns and detector are both heated to 408 K (35° C.). The samples are prepared in THF at about 0.5% weight, solvated about 2 hours with occasional shaking, and transferred to autosampler vials without filtering. An injection volume of 100 μL is used and data is collected for 25 minutes. Data collection and analyses are performed using ThermoLab Systems Atlas chromatography software and Polymer Laboratories Cirrus GPC software. Molecular weight averages are determined relative to a calibration curve (3^{rd} order) created using polystyrene standards covering the molecular weight range of 580-2,300,000 g/mol.

The PDMS, PPMS, and PCMS molecular structures are assayed from ¹H/¹³C NMR spectroscopic data using Varian INOVA 400 or Mercury 400 NMR spectrometers. The degree of polymerization is then calculated from the mass and structural data. The ¹H NMR spectra are recorded using a Varian Inova (500 MHz) spectrometer. Chemical shift values (δ) are expressed in ppm using signal of solvent residue as an internal standard (CHCl₃ at 7.26 ppm). The ¹³C NMR spectra are recorded using a Varian Inova (125 MHz) spectrometer and are expressed in ppm using solvent as the internal standard (CDCl₃ at 77.16 ppm). The results PCMS-1 and PCMS-2 samples are as follows:

PCMS-1—¹H NMR (CDCl₃): δ 1.74 (m), 1.20 (m), 0.55 (m), 0.09 (m), 0.08 (m) 0.05 (m), 0.01 (m), −0.02 (m).

¹³C NMR (CDCl₃): δ 28.03, 28.01, 27.99, 27.96, 27.87, 27.70, 27.63, 27.59, 27.57, 27.49, 27.12, 26.81, 26.76, 26.71, 26.67, 26.65, 2.09, 2.05, 1.97, 1.95, 1.52, 1.46, 1.38, 1.33, 1.30, 1.24, −2.14, −2.19, −2.24, −2.32.

PCMS-2—¹H NMR (CDCl₃): δ 1.72 (m), 1.20 (m), 0.56 (m), 0.09 (m), 0.10 (m) 0.03 (m), −0.01 (m), −0.02 (m).

¹³C NMR (CDCl₃): δ 28.03, 28.02, 27.99, 27.95, 27.90, 27.74, 27.72, 27.69, 27.60, 27.18, 27.16, 27.14, 26.88, 26.83, 26.81, 26.68, 2.10, −1.93, −2.02, −2.10, −2.36.

Density & Viscosity Measurements—

A Cannon CT-2000 constant temperature bath is used to simultaneously measure the density, ρ, and kinematic viscosity, u, from 303 to 398K. The density of each siloxane sample was calculated from precision measurements of the mass and volume. Cannon-Fenske capillary viscometers were used to measure kinematic viscosity. The absolute viscosity, η, was obtained from measurements of the kinematic viscosity and the density.

Film Thickness Measurements—

A PCS thin-film tribometer is used to measure elastohydrodynamic lubricant film thickness from 303 to 398K+/−1K. A polished AISI 52100 steel ball of 19.050 mm diameter is partly immersed in the test fluid and pressed against an optically transparent glass disk. The respective Young's moduli of the glass disk and steel ball are 75 and 210 GPa resulting in a maximum Hertzian pressure of 0.54 GPa under a 20 N load. The disk has a 500 nm thick silica spacer layer allowing measurement of lubricant film thicknesses with a precision up to 1 nm for films under 30 nm, and within 5% for film thicknesses >30 nm. The r.m.s. roughness of the steel ball and glass disk are 14 nm and 5 nm, respectively. The composite roughness, R_{qc}, is approximately 15 nm.

Film thickness measurements are undertaken in nominally pure rolling conditions with the disk velocity, U₁, varying from 0.020 m/s to 4.35 m/s. In nominally pure rolling, the ball is completely driven by the disk. Additional measurements are made with the ball attached to a motor-driven shaft to allow independent variation of the ball velocity U₂. This arrangement allows additional film thickness measurements at different slide-to-roll ratios, Σ, ranging from pure rolling (Σ=0) to pure sliding (Σ=2) as defined in Equation 3.

$$Σ = \frac{Sliding Speed}{Entrainment Speed} = \frac{\vert {U}_{1} - {U}_{2} \vert}{( {U}_{1} + {U}_{2} ) / 2} \qquad Eq . ( 3 )$$

Friction Measurement—

The friction coefficients, μ, of the test fluids are measured on the same PCS instrument used to measure film thickness. Friction is also measured from 303K to 398K, with temperature controlled to +/−1 K for each test in the temperature sequence. Friction tests are conducted using a 19.050 mm diameter AISI 52100 steel ball applied to a steel disk. The respective surface roughness of the disk and ball were about 30 nm and 5 nm, respectively. The Young's moduli of the steel ball and steel disk are both 210 GPa, resulting in a maximum Hertzian pressure of 0.82 GPa under a load of 20 N. The composite surface roughness is calculated to be approximately 30 nm.

A new steel ball and a new disk track are used for every test in the film formation and friction measurements. The reservoir, ball carriage, disk and ball are thoroughly cleaned with isopropyl alcohol and hexane, then allowed to dry before each test. The friction coefficient is measured at a fixed slide to roll ratio of Σ=0.50 while the disk velocity is varied from 0.025 to 5.00 m/s. The radial position of the ball used in the friction tests is varied from 42 to 44 mm in order to minimize the contribution of a spin component to the overall friction measurements. Because all friction measurements were made at these radii, the precision is within 3% for friction measurements.

### Example 2

### Preparation of Polysiloxane Traction Fluids

The high molecular rigidity noted for the PPMS samples was augmented by hydrogenation of the phenyl rings to produce poly(cyclohexylmethyl)siloxanes (PCMS). Two samples of PCMS were synthesized from the PPMS samples that exhibited the best traction performance. A sample of trimethyl silyl terminated poly(diphenylmethyl diphenyl)siloxane (PDPS) with 50% diphenyl D units and 50% phenylmethyl D units was also procured for film formation and friction testing. The increased phenyl content of the PDPS sample increases the molecular rigidity of the fluid in anticipation of greater traction performance

Four poly(phenylmethyl dimethyl)siloxane (PPMS-1 to PPMS-4), two poly(cyclohexylmethyl dimethyl)siloxane (PCMS-1 & PCMS-2) samples, and one poly(diphenylmethy dimethyl)siloxane (PDPS-1) are prepared and stored for testing and use as a traction fluid according to the teachings of the present disclosure. The trimethyl silyl-terminated poly(phenylmethyl dimethyl)siloxane and poly(diphenylmethyl dimethyl)siloxane samples may be obtained from a commercial source (Dow Corning Corporation, Midland, Mich.) or synthesized by any manner known to one skilled in the art.

The poly(cyclohexylmethyl dimethyl)siloxane (PCMS-1 and PCMS-2) samples are synthesized by complete hydrogenation of corresponding poly(phenylmethyldimethyl)siloxane using palladium on activated charcoal as the heterogeneous catalyst according to Equation 4. The reaction is carried out in a pressurized reactor at 413K (140° C.) and a H₂ pressure of 4.14 MPa with no solvent. Complete synthesis requires approximately 24 hours with several recharges to make up for consumed hydrogen. The final product is filtered through celite to remove the catalyst, and then characterized by NMR spectroscopy and gel permeation chromatography.

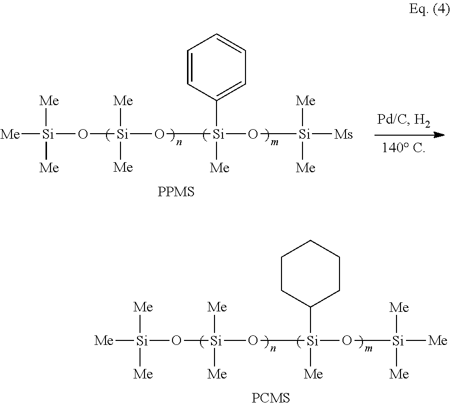

The synthesis of PCMS-1 & PCMS-2 samples are carried out in oven-dried flasks under a N₂ atmosphere. All reagents and catalysts are obtained from commercial vendors and used as received. A 100 mL Parr Micro Reactor equipped with a Teflon reaction vessel, a pressure gauge, an H₂ inlet, a mechanical stirrer, and heating is charged with 10 mL poly(phenylmethyl dimethyl)siloxane PPMS (e.g., PPMS-3 or PPMS-4) and 1 gram of 10% Palladium on Charcoal. After sealing and purging the reaction vessel with H₂, the reactor is heated to 413K with vigorous stirring and a H₂ pressure of 4.14 MPa. During the course of the reaction, the H₂ pressure is renewed when it falls below 3.45 MPa. The reaction is kept stirring until the pressure becomes constant. The reactor is then cooled to room temperature and the pressure released to the atmosphere. After carefully opening the reactor, the black residue is dissolved with hexanes, filtered through Celite, and the solvent removed under vacuum. The clear traction fluid obtained is then dried under high vacuum overnight to provide a pure product that is stored until used.

### Example 3

### Characterization of Polysiloxane Traction Fluids and the Use Thereof

The typical physical and chemical properties exhibited by the polysiloxane traction fluids prepared in Example 2 and labeled as sample #'s PPMS-1 to PPMS-4, PDPS-1, and PCMS-1 to PCMS-2 are summarized in Table 1 along with the properties of a conventional polydimethylsiloxane (PDMS) oil (Sample # C-1). These properties include information regarding molecular structure, mass, density, and viscosity including the percent branching, the type of branching, degree of polymerization (DP) and polydispersity (PD). The column headed percent D units indicates the percent of D units in each sample which are not dimethyl D units. Hence, the percent of non dimethyl D units in PDMS C-1 is zero as it consists entirely of polydimethylsiloxane (PDMS) oil. The percent phenylmethyl D unit content of the PPMS-1 to PPMS-4 samples includes 10%, 50% and 90%, as determined through analysis of nuclear magnetic resonance (NMR) data. Similarly, the percent cyclohexylmethyl D unit content of the PCMS-1, PCMS-2, and PDPS-1 samples are 50% or 90%. The structure of PCMS-1 and PCMS-2 has the same percentage of cyclohexylmethyl D units as phenylmethyl D units in the hydrogenated PPMS-3 and PPMS-4, but greater molecular mass.

Still referring to Table 1, the density and viscosity of the traction fluid samples and conventional oils is provided at three temperatures, namely, 303K, 348K, and 398K. Generally, an increase in density is observed to occur along with the molecular mass for polymers of similar molecular structure (e.g., branch content). The PPMS and PCMS samples have the highest density which increased with increasing phenyl content. The viscosity of the siloxanes increases with increasing phenyl and cyclohexyl content at a given molecular mass. Hydrogenation of PPMS to produce PCMS causes a significant increase in the viscosity at room temperature, increasing with phenyl content.

TABLE 1

| | | Molecular | | | | | | | Activation |
|---|---|---|---|---|---|---|---|---|---|
| | Percent | Mass | Density (g/cm³) | | | Viscosity (mPa · s) | | | Energy |
| Sample | D unit | (g/mol) | 303K | 348K | 398K | 303K | 348K | 398K | (kJ/mol) |
| PDMS (C-1) | 00 | 32000 | 0.96 | 0.92 | 0.88 | 937 | 423.3 | 213.2 | 15 |
| PPMS-1 | 10 | 8180 | 0.97 | 0.93 | 0.89 | 91.8 | 40.3 | 19.8 | 16 |
| PPMS-2 | 10 | 26600 | 0.99 | 0.94 | 0.9 | 443.3 | 202.4 | 98 | 16 |
| PPMS-3 | 50 | 2690 | 1.05 | 1.01 | 0.98 | 125.7 | 38.5 | 15.8 | 23 |
| PPMS-4 | 90 | 1990 | 1.07 | 1.04 | 1 | 472.1 | 68.7 | 21.8 | 33 |
| PCMS-1 | 50 | 2820 | 1.01 | 0.98 | 0.96 | 746.7 | 125 | 39.6 | 31 |
| PCMS-2 | 90 | 2090 | 1.03 | 1 | 0.97 | 19800 | 1523 | 242.1 | 47 |
| PDPS-1 | 50 | 1560 | 1.09 | 1.07 | 1.03 | 559.2 | 59 | 16.5 | 35 |

The Andrade-Eyring equation (see Equation 5) is used to calculate the activation energy of the traction fluids, where E is the activation energy, R is the universal gas constant, and T is the temperature. The low-shear viscosity reference η_{R} is calculated by fitting a line to the measured viscosity data and taking the limit to infinite temperature.

$${η}_{0} ( T ) = {η}_{R} \cdot {e}^{\frac{E}{RT}} \qquad Eq . ( 5 )$$

Still referring to Table 1, the activation energy is calculated over the entire temperature range. The addition of phenyl rings to produce PPMS decreases the temperature stability of viscosity that pure PDMS exhibits. The hydrogenation of the phenyl rings to cyclohexyl structures significantly increases the activation energy. In general, activation energy increases as the branch content and the hydrogen content of branches increases.

Referring now to FIGS. 2-5, measured film thickness is plotted as a function of entrainment speed at temperatures of 303K, 348K, and 398K. The film thicknesses calculated using the Hamrock-Dowson equation (see Eq. 1) are also plotted as solid lines using the measured viscosity and interpolated pressure-viscosity at the same temperatures as the film formation measurements. Measured and calculated film thickness are plotted in descending order at temperatures of T=303K, 348K, and 398K, respectively. The film thickness at a given speed decreases with increasing temperature due to the simultaneous decrease in the viscosity and the pressure-viscosity index. High molecular mass samples of PDMS and PPMS exhibit non-Newtonian shear-thinning behavior, which enables slip and limits the EHD friction coefficient for a given fluid. Therefore, the traction fluids prepared according to the teachings of the present disclosure are highly branched with relatively lower molecular mass to prevent shear-thinning.

The film thickness for the different traction fluids is calculated from their viscosity and pressure-viscosity index (α*) using Equation 1 at the test temperatures. The pressure-viscosity index for PDMS and PPMS are obtained by curve fitting to published data. The pressure viscosity index of PPMS with high phenylmethyl content is around 27 GPa⁻¹, but decreases significantly at higher temperatures.

The Equation 1 very accurately predicts film thickness for all of the samples under consideration with a logarithmic slope approached 0.67. The close fit of measured and calculated film thickness for the PPMS and PCMS indicates that the fluids being investigated for CVT applications show Newtonian behavior, and thus exhibit no shear thinning in the inlet where film thickness is formed.

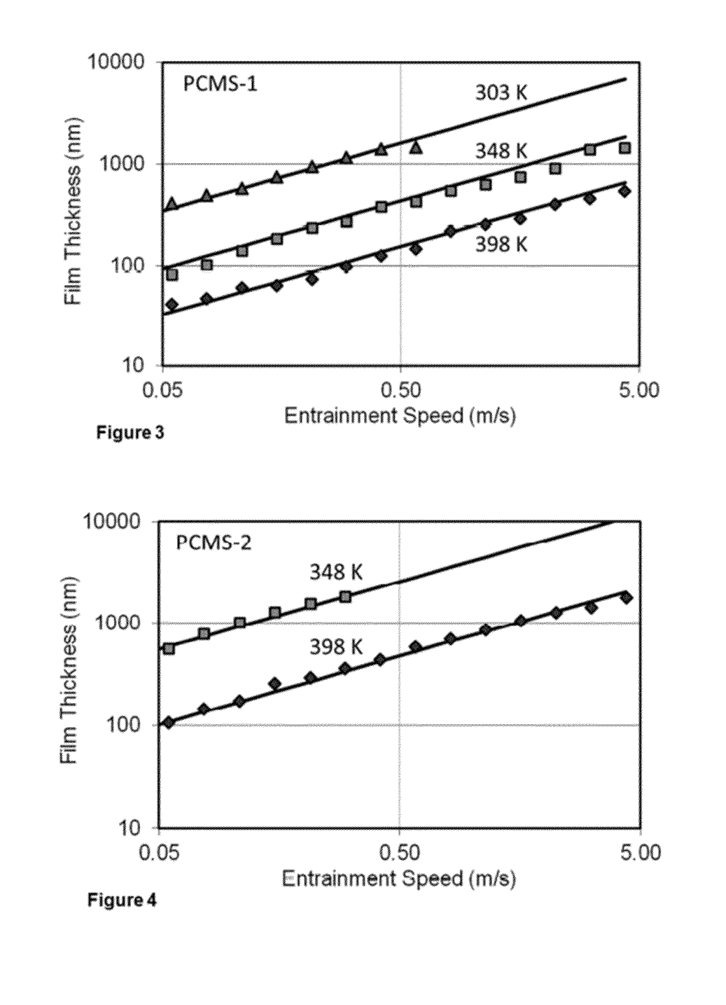

Referring now to FIGS. 2 and 3, the film forming ability of PPMS and PCMS, respectively, is demonstrated. The hydrogenation of PPMS-3 to produce PCMS-1 increases the viscosity and the pressure-viscosity indices sufficient to increase film thickness significantly even though the two samples have the same branch content and degree of polymerization. However, FIG. 3 demonstrates that the higher activation energy of PCMS-1 simultaneously causes a greater decrease in the viscosity and the pressure-viscosity index with increasing temperature, resulting in a greater variation of film thickness.

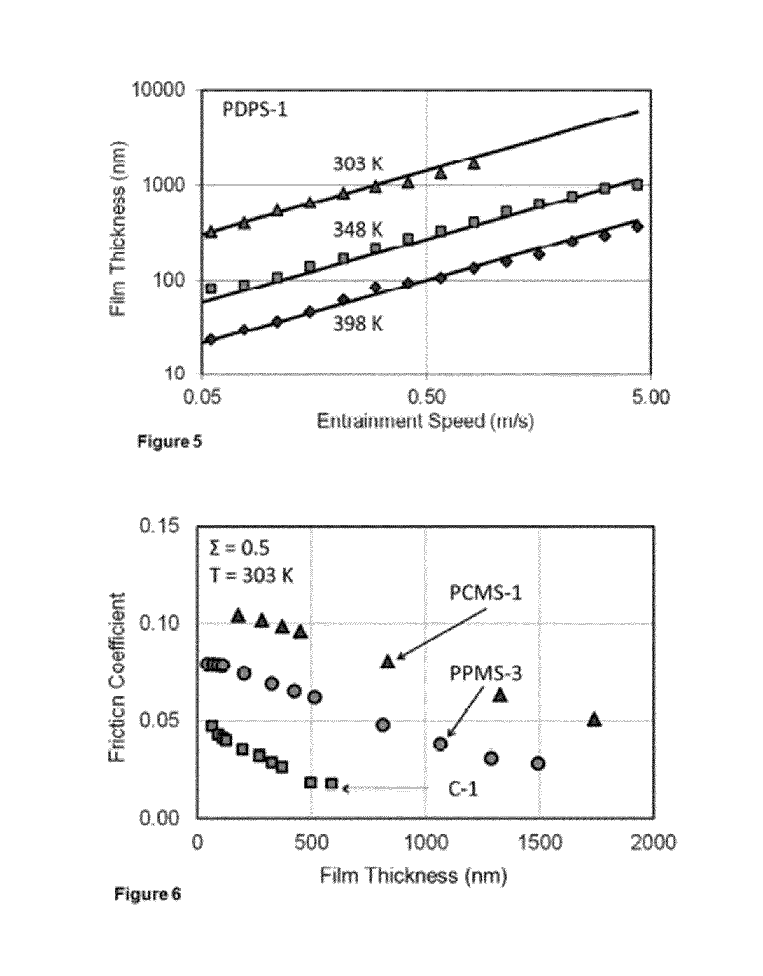

Referring now to FIGS. 4 and 5, the film thickness of PCMS-2 and PDPS-1 samples is shown as a function of entrainment speed. The high viscosity of the PCMS-2 sample at 303K contributes to film thicknesses that exceed the measurement capability of the test instrumentation, so data at that temperature is not provided. The samples exhibit the logarithmic slope of approximately 0.67 when modeled by the Equation 1, which is characteristic of Newtonian fluids. Neither the PCMS-2 nor the PDPS-1 samples exhibit the shear-thinning behavior that is characteristic of typical high mass polysiloxanes, indicating they remain Newtonian over the entire entrainment speed range.

The pressure-viscosity indices for PDMS, PPMS, PCMS, and PDPS samples are provided in Table 2. These pressure-viscosity indices are interpolated from high pressure viscometric data using the procedure described by Zolper et al. in an article entitled “Lubrication Properties of Poly-alpha-olefin and Polysiloxane Lubricants: Molecular Structure-Tribology Relationships” published in Tribol. Lett (2012), the entire contents of which are hereby incorporated by reference. The PCMS and PDPS samples also exhibit a high pressure-viscosity index similar to that exhibited by highly branched PPMS.

The pressure-viscosity indices of the PCMS samples are higher than those of PPMS because of the increased dimensions and flexibility of the cyclohexyl versus phenyl branches. The PDPS samples also exhibit higher pressure-viscosity indices than PPMS samples because of the increased density of phenylmethyl D unit groups. This effect is attributed to the increased molecular rigidity caused by bulky, rigid branches. These results are in agreement with the observed effects of ring structures on the pressure-viscosity indices of hydrocarbons and polysiloxanes.

TABLE 2

| | Pressure-Viscosity | | |
|---|---|---|---|
| | Index (GPa⁻¹) | | |
| Sample | 303 K | 348 K | 398 K |
| PDMS (C-1) | 15 | 14.8 | 14.6 |
| PPMS-1 | 15.5 | 14.1 | 13 |
| PPMS-2 | 15.5 | 14.1 | 13 |
| PPMS-3 | 23.7 | 17.8 | 12.8 |
| PPMS-4 | 27 | 20.2 | 14.5 |
| PCMS-1 | 34.2 | 27.8 | 16.7 |
| PCMS-2 | ~ | 33.7 | 17.8 |
| PDPS-1 | 38.8 | 27.2 | 17.2 |

Friction and film thickness measurements are carried out for the same traction fluids using the same entrainment speed range at Σ=0.5 and temperatures of 303K, 348K, and 398K. Such common thermal and dynamic conditions allow the film thickness and friction coefficient data to be cross-plotted in order to determine the friction coefficient as a function of the lubrication regime. The PCMS-2 is too viscous to test at 303K, but at higher temperatures the performance is measurable. Cross-plots of film thickness and friction coefficient measured for the traction fluids are provided in FIGS. 6-8. A PDMS reference sample (C-1) with viscosity of 1000 mm²·s⁻¹ (cSt) at 303K is included in FIGS. 6-8 to provide a performance baseline.

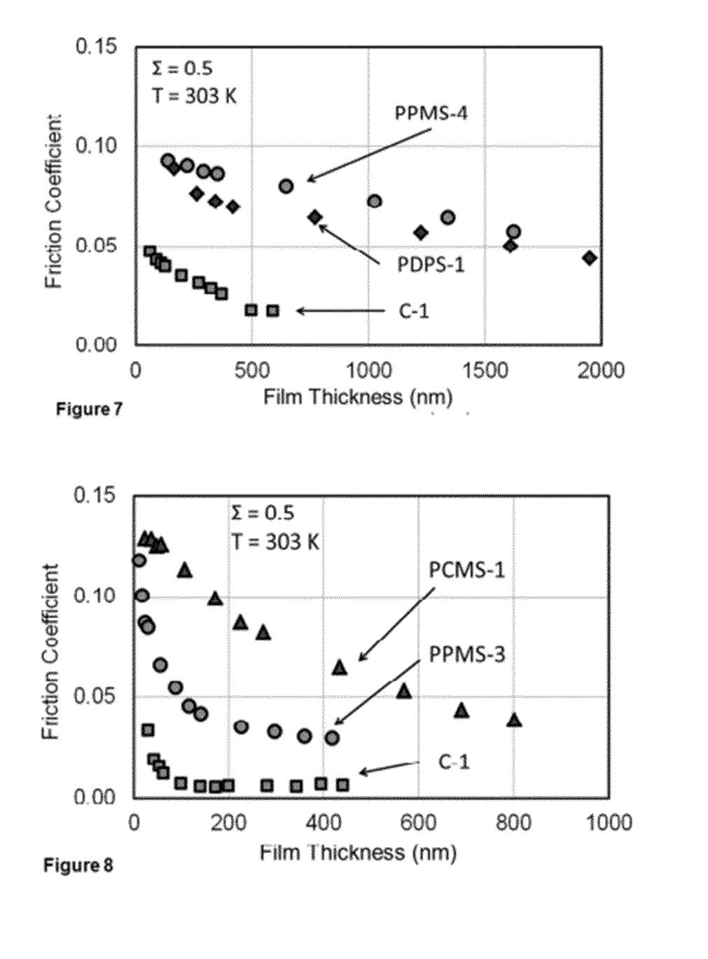

Referring now to FIGS. 6 and 7, the variation of friction coefficient as a function of film thickness at T=303K and Σ=0.5 is demonstrated. Pure PDMS maintains nearly constant EHD friction with increasing viscosity over the range of 10 mm²·s⁻¹ (cSt) to 1000 mm²·s⁻¹ (cSt), at a constant load, slide to roll ratio, and temperature. The introduction of phenyl branches in PPMS-4 causes a significant increase in EHD friction over that of PDMS (C-1). Furthermore, hydrogenation of PPMS to form PCMS causes a substantial increase in the EHD friction. In FIG. 6, the EHD friction of polysiloxanes with high phenylmethyl D unit content is illustrated. The PPMS-4 sample has higher EHD friction than the PPMS-3 sample, as would be expected from the increase in pressure-viscosity index. Note that although the PDPS-1 sample has higher phenylmethyl D unit content it also exhibits slightly lower EHD friction than PPMS-4 sample. Thus the projection of friction performance from the molecular structure only can yield unexpected results.

In FIG. 7, the lower friction of the PDPS-1 sample in comparison to that of the PPMS-4 sample illustrates the difficulty in ascribing EHD friction solely to molecular rigidity. This phenomenon lends credence to the hypothesis that EHD friction is partly influenced by interlocking molecular asperities of the test fluids. Although not wanting to be constrained by theory, one can argue that effective traction fluids have molecular structures with ‘pockets’ that can interlock with the asperities of other molecules.

Still referring to FIG. 7, the discrepancy between the performance of PPMS-4 and PDPS-1 samples indicates that an optimum number of molecular pockets and asperities for a traction fluid may augment the EHD friction contribution of molecular rigidity. The PPMS-4 sample contains about 45% phenyl branch rings (asperities) and 55% methyl branch groups (voids) along its length. In contrast, the PDPS-1 sample has about 75% phenyl branch rings (asperities) and 25% methyl branch groups (voids) along its length. The additional phenyl asperities in PDPS-1 may decrease the likelihood of interlocking of neighboring molecules, thus limiting EHD friction.

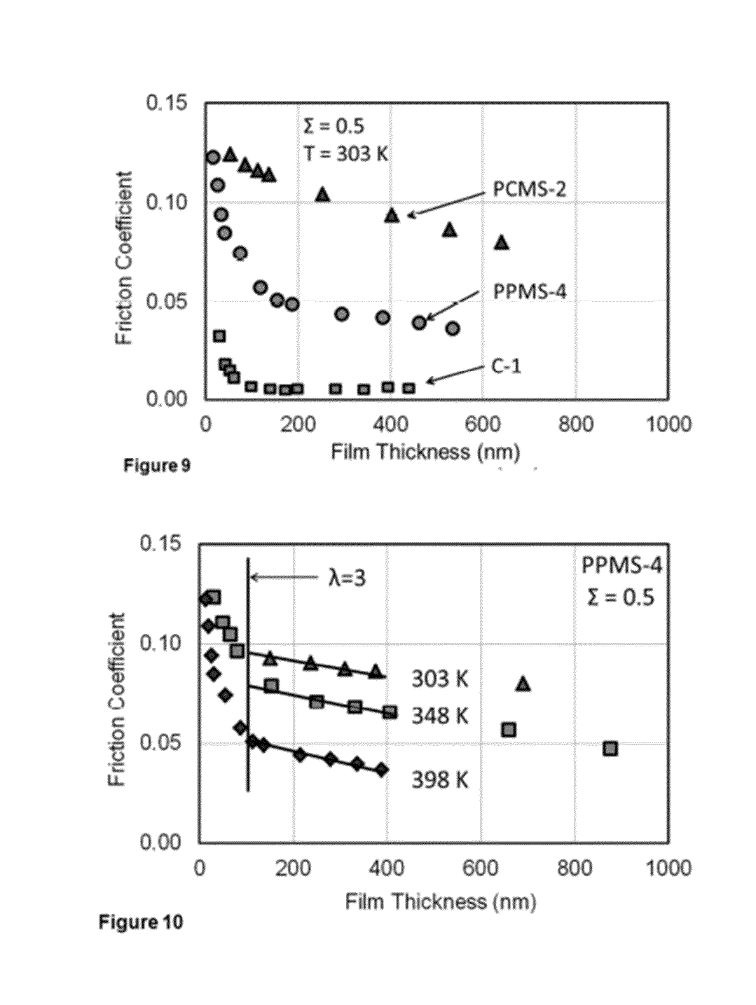

Referring now to FIGS. 8 and 9, the variation of friction coefficient as a function of film thickness at T=398K and Σ=0.5 is demonstrated. The data for PDMS (C-1) and PPMS samples at low film thicknesses illustrate the transition from boundary to full-film lubrication. At high temperatures, the films are thinner, so that boundary friction is visible on the left of the figures. The friction then decreases with increasing entrainment speed until the film thicknesses, a product of entrainment speed, exceeds the composite roughness of the disk and ball. The PPMS samples exhibit a steady increase in EHD friction as the phenyl branch content is increased. This phenomenon is also observed for the PCMS samples.

The friction coefficient of the PPMS samples decreases more significantly as temperature is increased. The PCMS samples exhibit the greatest stability of performance over the temperature range tested; they offer higher friction than the PPMS samples with the same branch content at room temperature (see FIGS. 6-7). Moreover, the hydrogen saturation of PPMS to produce PCMS causes a substantial increase in viscosity as well as film formation and EHD friction coefficient. When the temperature is raised to 398K, the PCMS samples still offer higher friction relative to the PPMS samples which exhibit significantly greater temperature dependence (see FIGS. 8-9). At higher temperatures, the PDMS reference sample exhibits stable friction as film thickness increases while the friction of PCMS and PPMS generally decreases.

As film thickness increases, the lubrication regime, λ, transitions from boundary to mixed and finally full film lubrication (conservatively, λ=h_{c}/R_{qc}>3). The lubrication regimes are associated with distinct changes in friction, with EHD friction occurring in the full film regime. The boundary and mixed frictional regimes intersect with the EHD frictional regime for PPMS-4 sample over the test temperature range as shown in FIG. 10. The limiting EHD friction coefficient is just outside the mixed lubrication regime, and represents the shear stress sustained by the fluid film with minimum influence from the effects of shear heating. FIG. 10 illustrates how the limiting EHD friction is determined from the intersection of lines of measured EHD friction at the transition from mixed to full film lubrication.

The limiting EHD friction coefficients for the polysiloxanes tested over the temperature range are summarized in Table 3. In most cases, a clear transition from mixed lubrication to full film lubrication (λ=3) is visible in the cross plots of film thickness and friction coefficient. In some cases, such as the low temperature PPMS-4 data (see FIG. 9), friction in the boundary and mixed lubrication regimes is not measureable due to the thick film formation at low speeds. In such cases, the limiting EHD friction was approximated by extrapolating the EHD friction to the intersection of mixed and full film friction data based on high temperature data as illustrated in FIGS. 9-10.

TABLE 3

| | Elastohydrodynamic | | |
|---|---|---|---|
| | Friction Coefficient | | |
| Sample | 303 K | 348 K | 398 K |
| PDMS (C-1) | 0.042 | 0.018 | 0.007 |
| PPMS-1 | 0.051 | 0.022 | 0.016 |
| PPMS-2 | 0.052 | 0.024 | 0.016 |
| PPMS-3 | 0.077 | 0.062 | 0.035 |
| PPMS-4 | 0.093 | 0.074 | 0.052 |
| PCMS-1 | 0.105 | 0.098 | 0.086 |
| PCMS-2 | ~ | 0.118 | 0.11 |
| PDPS-1 | 0.092 | 0.083 | 0.075 |

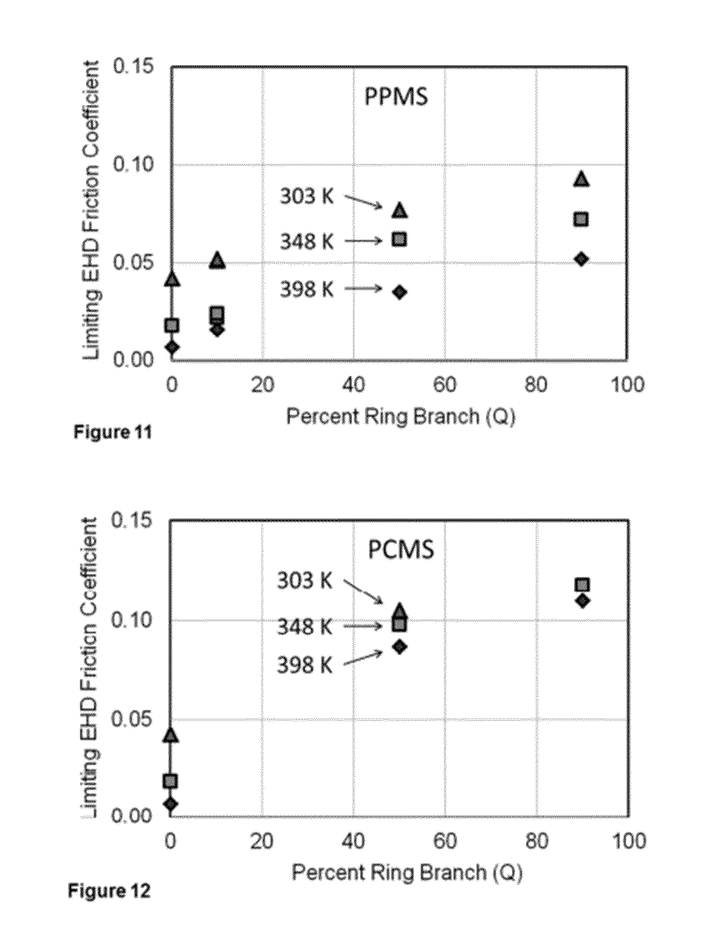

In FIGS. 11 and 12 the relationship between the ring-shaped branch content and the limiting EHD friction coefficient for PPMS and PCMS samples is depicted. Both data sets are compared to the limiting EHD friction of PDMS (C-1) with no ring branch content. It is evident that as phenyl branch or phenylmethyl D unit content increases, the overall EHD friction increases (FIG. 11). Hydrogenation of the phenyl rings to cyclohexyl groups causes a substantial increase in the limiting EHD friction (FIG. 12). PCMS also has higher temperature stability of EHD friction than does PPMS. These results demonstrate the correlation between ring branch content and EHD friction in the siloxane-based traction fluids.

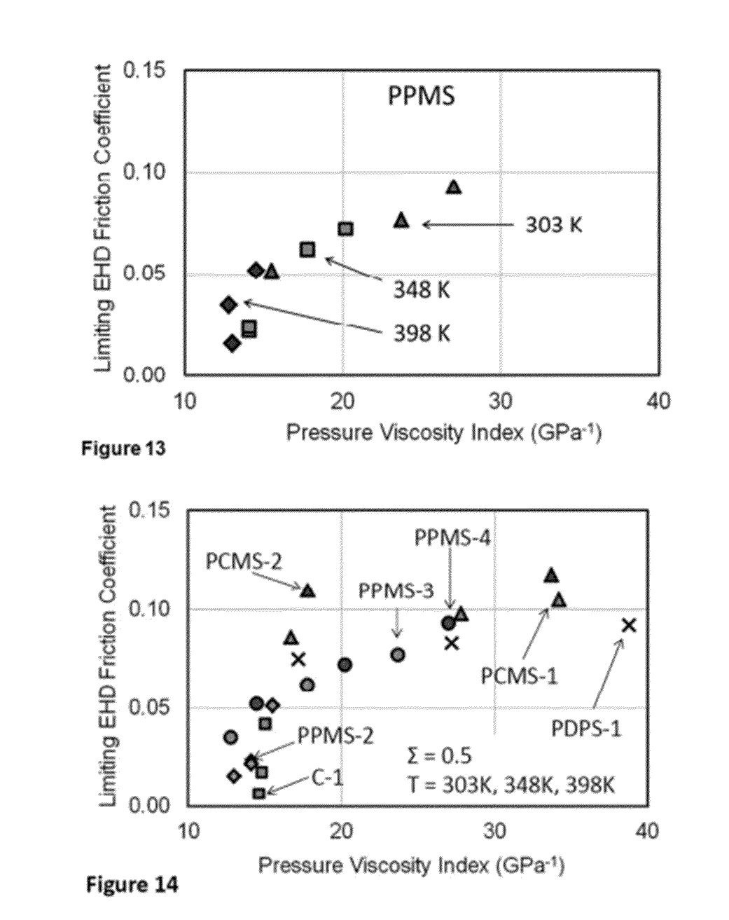

Referring now to FIGS. 13 and 14, the pressure viscosity index data of Tables 2 is graphically shown plotted against the limiting EHD friction coefficient of Table 3. In general, a positive correlation between the two properties is demonstrated. For the PPMS samples, there is a strong correlation between pressure-viscosity index and limiting EHD friction coefficient (see FIG. 13).

The correlation between pressure-viscosity index and limiting EHD friction is not as distinct when examined for all of the samples tested (see FIG. 14). Nevertheless, a trend can be largely drawn at individual temperatures to relate pressure-viscosity index to the limiting EHD friction coefficient.

A polysiloxane lubricant prepared and used according to the present disclosure can exhibit broad traction performance depending on its length, branch content, and branch structure. Polysiloxanes with a high content of aryl and cycloalkyl ring structures have higher EHD friction than polysiloxanes without ring branch structures, such as PDMS. For polysiloxanes with the same ring content, larger cycloalkyl branches (PCMS) increase EHD friction more than aryl branches (PPMS). There is an optimum density of ring branches to maximize the contribution of molecular interlocking to EHD friction. The optimum is approached by PPMS-4 and PCMS-2 but exceeded by PDPS-1. Increasing polysiloxane ring branch density and ring branch dimensions causes an increase in molecular rigidity, resulting in a rigid rod like conformation, which contributes to high pressure-viscosity index as well as high EHD friction. Polysiloxanes with the same percentage branch density exhibit higher and more temperature stable EHD friction with larger, more flexible ring structures (cyclohexyl) than do polysiloxanes with smaller, more rigid rings (phenyl).

The viscosity and pressure-viscosity indices of highly branched polysiloxanes decrease significantly with increasing temperature, in accordance with a correlation between activation energy and pressure-viscosity index. A positive correlation exists between pressure-viscosity index and the limiting EHD friction coefficient for the polysiloxane traction fluids prepared and used according to the present disclosure. The observed correlation is greater in materials with the same type of branch structures.

The correlations of branch content to traction performance as well as the noted invariance of pressure-viscosity index with respect to degree of polymerization for the traction fluids of the present disclosure indicates that the viscosity may be reduced by reducing degree of polymerization. As long as the branch type and content remains the same, the species of polysiloxane traction fluids herein are expected to maintain similar traction performance regardless of degree of polymerization. Therefore, viscosity dominated phenomenon, such as film formation and fluid circulation, may be varied for different applications while maintaining reasonably high EHD friction.

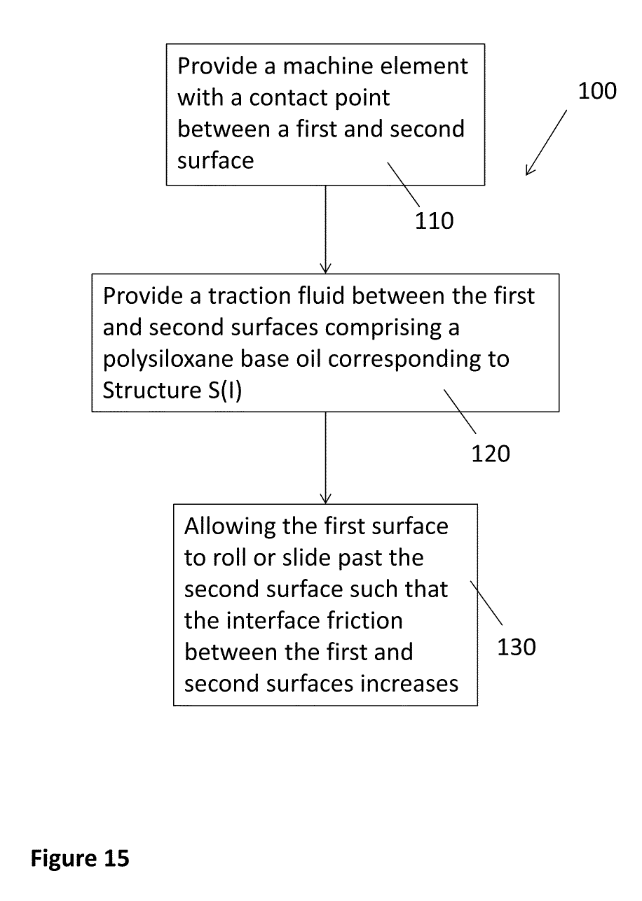

According to another aspect of the present disclosure, a method of increasing the interface friction between rolling or sliding surfaces in a machine element is provided. Referring now to FIG. 15, the method 100 generally comprises the steps of providing a machine element 110 having a first and second surface; providing a traction fluid 120 between the first and second surfaces; and allowing the first surface to roll or slide past the second surface 130, the traction fluid causing the interface friction between the first and second surfaces to increase. In this method, the two surfaces represent a tribological interface under elastohydrodynamic lubrication (EHL) in the machine element. Alternatively, the first and second surfaces are ceramic or metal surfaces; alternatively, the two surfaces are metal surfaces. The machine element may include, but not be limited to, a rolling element bearing, a sliding bearing, a gear, a cam and cam follower, or a traction drive.

The traction fluid used in this method 100 may include any of the polysiloxane base oils described herein corresponding to Structure S(III) as previously described herein; alternatively, the polysiloxane base oils correspond to either Structure S(II) or S(IV) as previously described herein. Optionally, the traction fluids may further comprise at least one functional additive selected as one from the group of extreme pressure additives, anti-wear additives, antioxidants, antifoams, metal deactivators, detergents, dispersants, antibacterial agents, antiseptics, tackiness additives, friction modifiers, and corrosion inhibitors known to one skilled in the art. The traction fluid may also comprise a compatible base oil that has a degree of polymerization between 15 and 500 with the compatible base oil being selected as polydimethylsiloxane or poly(phenylmethyl dimethyl)siloxane with between 5 and 30 wt. % phenylmethyl D unit content.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A traction fluid capable of increasing the interface friction between two mechanical surfaces when the surfaces are moved relative to one another, the traction fluid comprising:
a polysiloxane base oil corresponding to the structural formula: 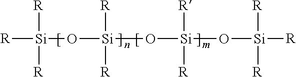
wherein R and R′ are independently selected, such that R is an alkyl group having between 1-3 carbon atoms; R′ is a cycloalkyl or dicycloalkyl group having between 5-20 carbon atoms; m is an integer; and n is an integer or 0 with
5<(m+n)<100 and 0.50<m/(m+n)<1.00.

2. The traction fluid according to claim 1, wherein R is a methyl group and R′ is a cyclohexyl or cyclopentyl group.

3. The traction fluid according to claim 1, wherein the traction fluid further comprises at least one functional additive selected as one from the group of extreme pressure additives, anti-wear additives, antioxidants, and corrosion inhibitors.

4. The traction fluid according to claim 1, wherein the traction fluid further comprises one or more compatible base oils having a degree of polymerization between 15 and 500; the compatible base oil selected as polydimethylsiloxane or poly(phenylmethyl dimethyl)siloxane with between 5 and 30 wt. % phenylmethyl D unit content.

5. The use of at least one polysiloxane base oil as a low wear, traction fluid capable of increasing the interface friction between two mechanical surfaces when the surfaces are moved relative to one another, the polysiloxane base oil corresponding to the structural formula: 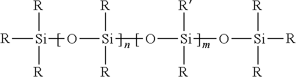
wherein R and R′ are independently selected, such that R is an alkyl group having between 1-3 carbon atoms; R′ is a cycloalkyl or aryl group having between 5-20 carbon atoms; m is an integer; and n is an integer or 0 with 5<(m+n)<100 and 0.50<m/(m+n)<1.00.

6. The use of the low wear, traction fluid according to claim 5, wherein R is a methyl group and R′ is an aryl or a cycloalkyl group with 7<(m+n)<100.

7. The use of the low wear, traction fluid according to claim 5, wherein R is a methyl group and R′ is a diaryl or a dicycloalkyl group.

8. The use of the low wear, traction fluid according to claim 5, wherein R is a methyl group and R′ is a cyclohexyl or cyclopentyl group.

9. The use of the low wear, traction fluid according to claim 5, wherein the polysiloxane base oil corresponds to structural formula:

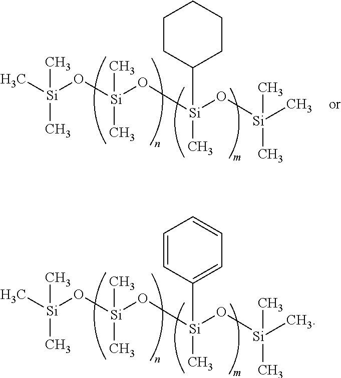

10. The use of the low wear, traction fluid according to claim 5, wherein the polysiloxane base oil further comprises at least one functional additive selected as one from the group of extreme pressure additives, anti-wear additives, antioxidants, and corrosion inhibitors.

11. The use of the low wear, traction fluid according to claim 5, wherein the polysiloxane base oil further comprises one or more compatible base oils having a degree of polymerization between 15 and 500; the compatible base oil selected as polydimethylsiloxane or poly(phenylmethyl dimethyl)siloxane with between 5 and 30 wt. % phenylmethyl D unit content.

12. The use of the low wear, traction fluid according to claim 5, wherein the two mechanical surfaces that move relative to one another are part of a traction drive.

13. The use of the low wear, traction fluid according to claim 5, wherein the traction fluid is a grease, a gear oil, or a transmission fluid.

14. A method of increasing the interface friction between two mechanical surfaces when the surfaces are moved relative to one another, the method comprising the steps of:
providing a machine element having a first surface and a second surface; the first and second surfaces being in contact with one another in the machine element;
providing a traction fluid between the first surface and second surface, the traction fluid comprising:
at least one polysiloxane base oil corresponding to the structural formula: 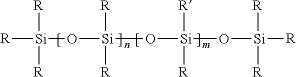
wherein R and R′ are independently selected, such that R is an alkyl group having between 1-3 carbon atoms; R′ is a cycloalkyl or aryl group having between 5-20 carbon atoms; m is an integer; and n is an integer or 0 with 5<(m+n)<100 and 0.50<m/(m+n)<1.00; and
allowing the first surface to roll or slide past the second surface such that the traction fluid increases the interface friction between the first and second surfaces.

15. The method according to claim 14, wherein R is a methyl group and R′ is an aryl or a cycloalkyl group with 7<(m+n)<100.

16. The method according to claim 14, wherein R is a methyl group and R′ is a diaryl or a dicycloalkyl group.

17. The method according to claim 14, wherein R is a methyl group and R′ is a cyclohexyl or cyclopentyl group.

18. The method according to claim 14, wherein the polysiloxane base oil corresponds to the structural formula:

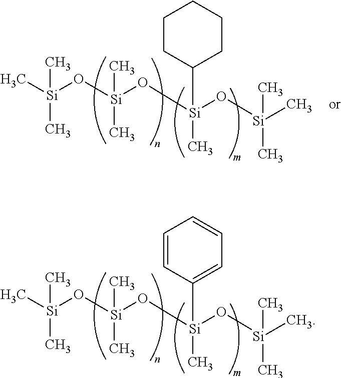

19. The method according to claim 14, wherein the traction fluid further comprises at least one functional additive selected as one from the group of extreme pressure additives, anti-wear additives, antioxidants, and corrosion inhibitors.

20. The method according to claim 14, wherein the traction fluid further comprises one or more compatible base oils having a degree of polymerization between 15 and 500; the compatible base oil selected as polydimethylsiloxane or poly(phenylmethyl dimethyl)siloxane with between 5 and 30 wt. % phenylmethyl D unit content.

21. The method according to claim 14, wherein the two mechanical surfaces that move relative to one another are part of a traction drive.
